(19) United States
(12) Patent Application Publication
(10) Pub. No.: US 2003/0099104 A1
(43) Pub. Date: May 29, 2003

(54) Lighting fixture with image projection effects

(76) Inventor: Shan-Der Hou, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/993,693

(22) Filed: Nov. 27, 2001

(51) Int. Cl. F21L 4/00

(52) U.S. Cl. 362/202; 362/116; 362/208

(57) ABSTRACT

A lighting fixture with image projection effects comprises a projection pattern piece, a lens, a light source and a casing. The light source is inside the casing and a through hole is provided in front of the casing. The lens is inserted into the through hole with the projection pattern piece placed between the light source and the lens. The projection pattern piece is hollowed out at its center in a contour of a selected pattern. Light beams emitted from the light source are projected through the hollowed-out hole to the lens, then converged and amplified to project the image of the pattern.

### BACKGROUND OF THE INVENTION

(a) Field of the Invention

The present invention is related to a lighting fixture with image projection effects, and more particularly, to one that is portable for lighting and image projection.

(b) Description of the Prior Art

A key-chain light or a flash light offering good mobility as a portable lighting fixture was once very popular, particularly, as a give-away in sales promotion campaigns. However, the flashlight or key-chain light is no longer attractive since it carries only a single purpose of lighting without any other added function. As a result, very few people now would like to carry it along or spend money to buy one. This is indeed a shame that the portable lighting function of the flashlight or the key-chain light is so neglected.

### SUMMARY OF THE INVENTION

The primary purpose of the present invention is to provide a portable lighting fixture provided with image projection effects. The lighting fixture comprises a projection pattern piece, a convergence lens, a light source and a casing. Wherein, the light source is inside the casing, a through hole is provided in front of the casing, and a convex lens or a plano-convex lens is inserted the hole to converge the light. The projection pattern piece placed between the light source and the convergence relates to one provided with a hollow or perforated contour of a pattern so that the light from the light source is converged through the projection pattern piece by the lens to project a apparently visible image to add fin to the practical use of lighting, and thus to attract the consumer to buy one.

### BRIEF DESCRIPTION OF THE DRAWINGS

FIG. 1 is an exploded view of a first preferred embodiment of the present invention;

FIG. 2 is a sectional view of an assembly of the first preferred embodiment of the present invention;

FIG. 3 is a view showing that the first preferred embodiment of the present invention is in practice;

FIG. 4 is a perspective view of a second preferred embodiment of the present invention;

FIG. 5 is a sectional view of an assembly of the second preferred embodiment of the present invention;

FIG. 6 is an exploded view of a third preferred embodiment of the present invention;

FIG. 7 is an exploded view of a fourth preferred embodiment of the present invention;

FIG. 8 is a sectional view of an assembly of a fifth preferred embodiment of the present invention;

FIG. 9 is a view showing the fifth preferred embodiment of the present invention in practice; and

FIG. 10 is a view showing a sixth preferred embodiment of the present invention in practice.

### DETAILED DESCRIPTION OF THE PREFERRED EMBODIMENTS

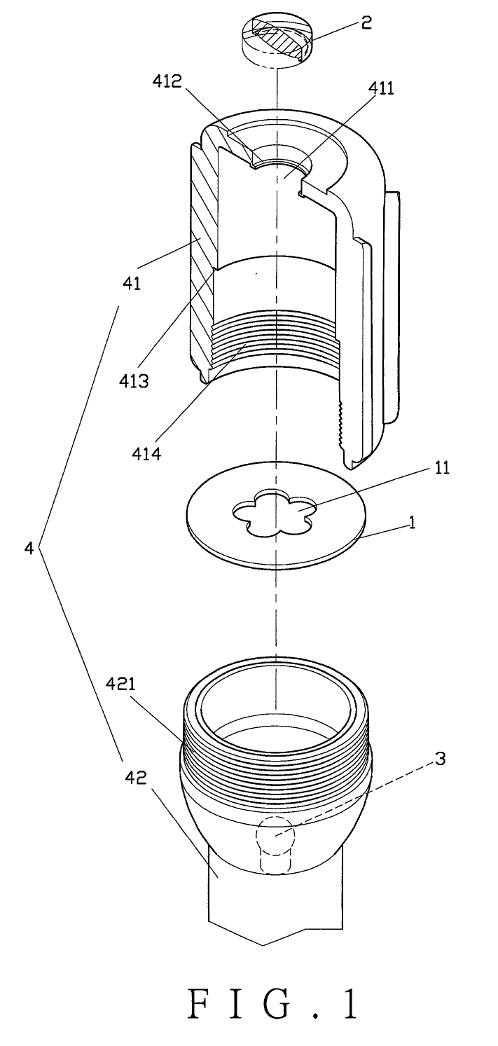

Referring to FIG. 1, a first preferred embodiment of the present invention applied in a flashlight includes a projection pattern piece (1), a convergence lens (2), a light source (3) and a casing (4).

The projection pattern piece is a plate in proportion with that of the light source (3) and is hollowed out at its center a hole (11) having a contour of a selected pattern.

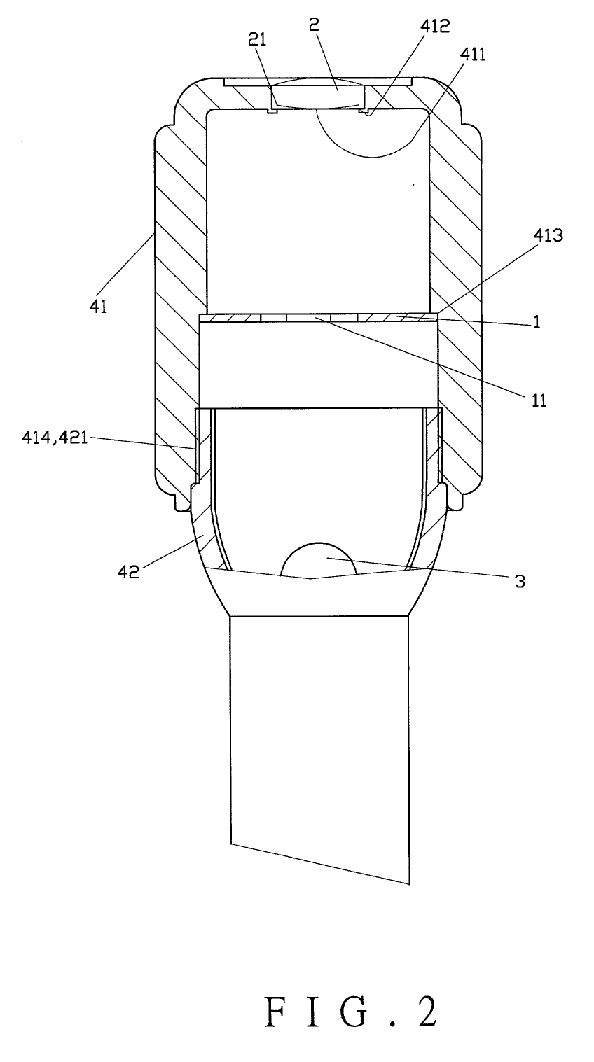

The lens (2) (a convex or a plano-convex lens, in this preferred embodiment, the former) converges and amplifies the light from the light source (3) to project the light. A circular gradation (21) is formed at the bottom edge of the lens (2) as illustrated in FIG. 2.

The light source (3) is a small electric bulb.

The casing (4) is a flashlight comprised of a housing (41) and a barrel (42). A hole (411) is provided at the front end of the housing (41), i.e. the front of the casing (4). A circular wall (412) is provided at the inner edge of the hole (411) and a circular retainer (413) is provided in recess at the center section of the housing (41). Female threads (414) are formed on the inner surface of an open end of the housing (41) and the light source (3) is provided inside the barrel (42) with male threads (421) on its outer surface.

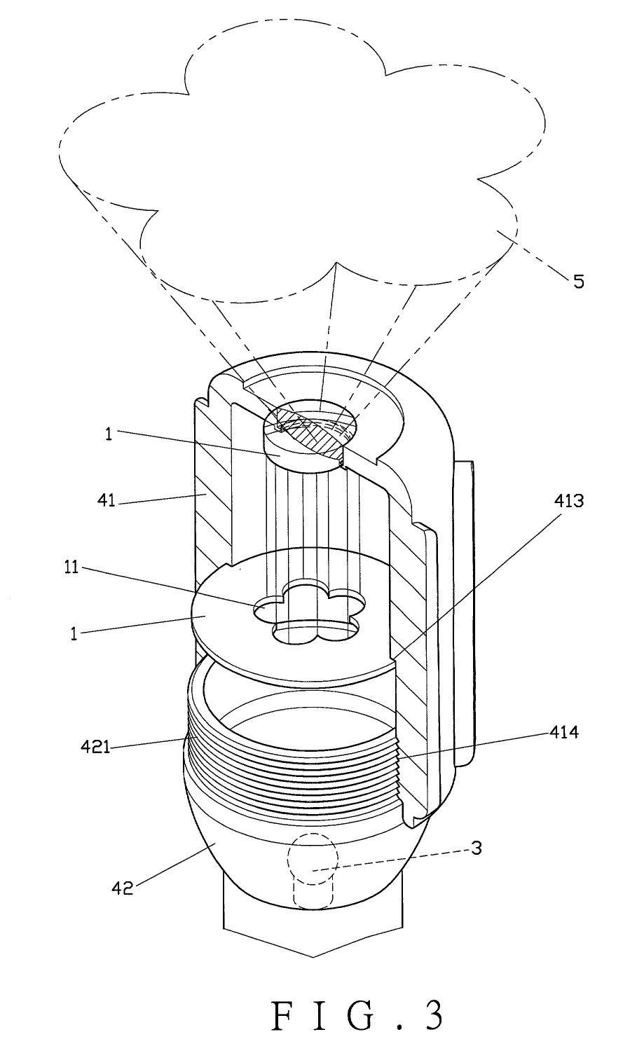

As illustrated in FIG. 2, the lens (2) is fixed to the hole (411) at the front of the housing (41) with adhesion. The wall (412) merely allows the gradation (21) of the lens (2) to flush rest in the hole (411). The projection pattern piece (1) is inserted in position to the retainer (413) on the inner of the housing (41) or glued inside the housing (41). The female threads (414) of the housing (41) are engaged with the male threads (421) at the front end of the barrel (42) with the hollowed-out hole (11) of the projection pattern piece (1) in the housing (41) to be located in front of the light source (3). As illustrated in FIG. 3, light beams emitted from the light source (3) are effectively projected on the lens (2) through the hollowed-out hole (11) depending on shape of the projection pattern piece (1). Whereas the lines (2) is a convex lens, the light beams arriving on the inner curvature of the lens (2) are converged and amplified on the outer curvature to project ax extremely clear image (5) of the hollowed-out configuration as defined by the projection pattern piece (1). Alternatively, a plano-convex lens may be used instead of a convex lens to achieve the similar effects.

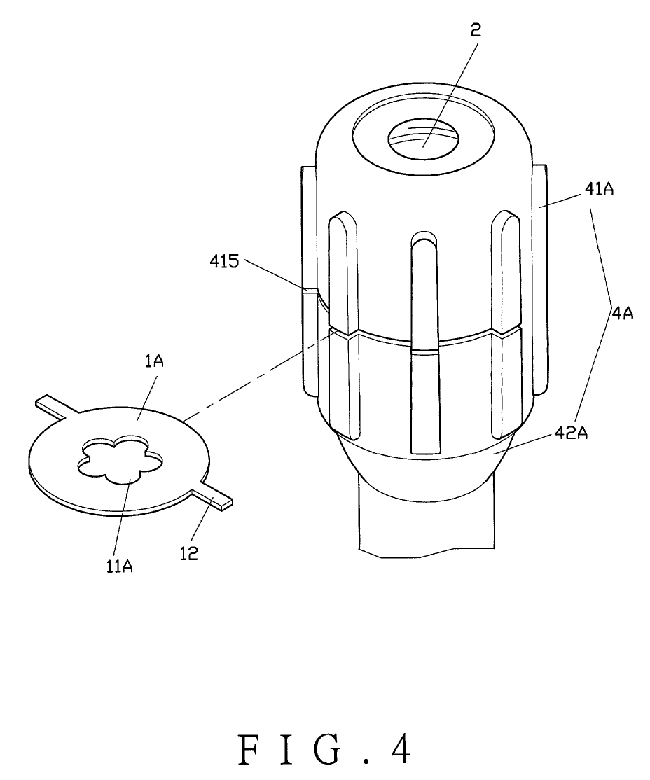

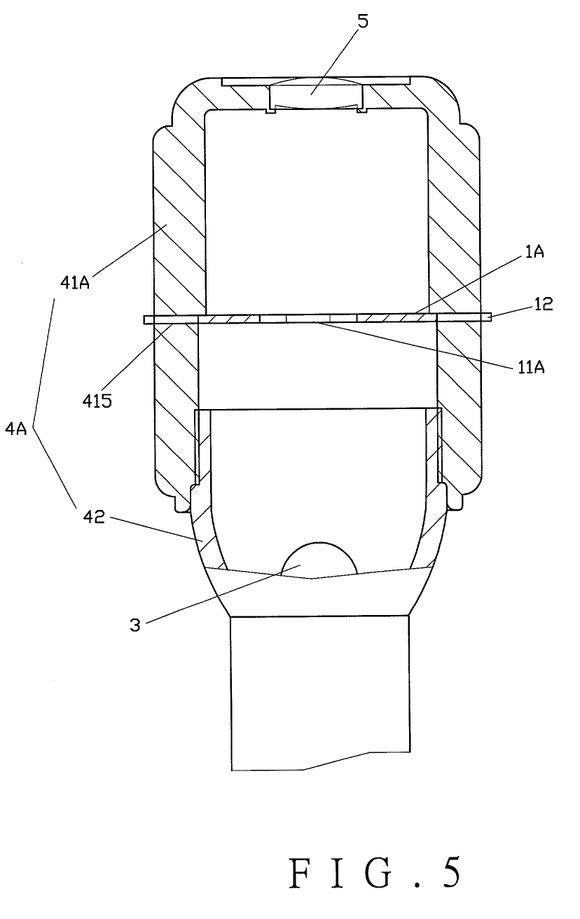

To provide even more diversified funs of the projected image, a projection pattern piece (IA) is exchangeable whenever desired by the user as illustrated in FIG. 4 showing a second preferred embodiment of the present invention. To achieve this, a slot (415) greater than 180 degrees is cut in radius on the housing (41A) in relation to a projection pattern piece (IA) and two bits (12) opposite to each other are protruding from the project pattern piece (1A). Referring to FIG. 5, the project pattern piece (1A) is inserted to the slot (415) of the housing (41A). Upon changing for another projection pattern piece (1A) with different pattern, the existing pattern piece (1A) exits easily simply by moving both of said two bits (12) protruding from the housing (41A).

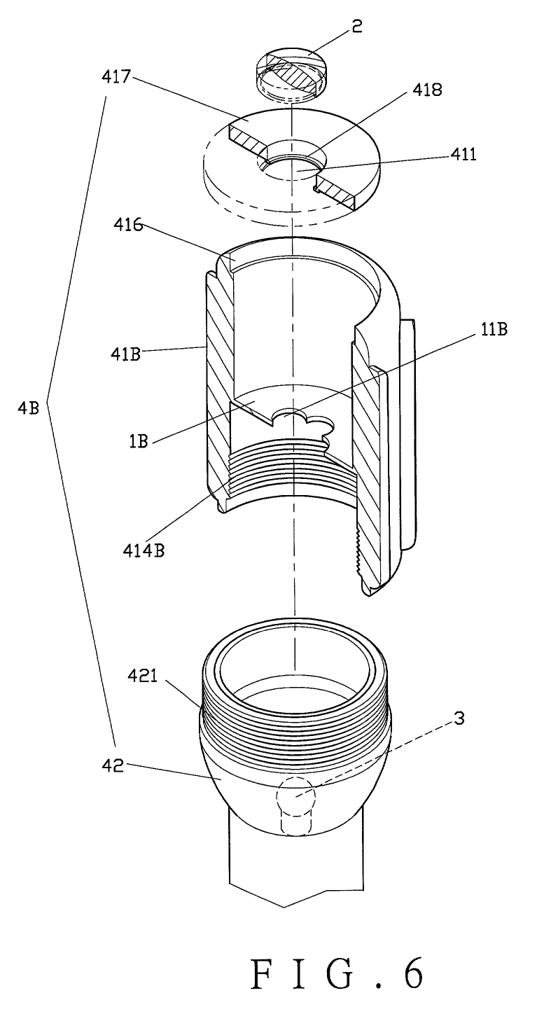

FIG. 6 shows a third preferred embodiment of the present invention. A projection pattern piece (1B) is directly formed on the inner of a housing (41B) and a hole (416) is provided on the front of the housing (41B). A positioning retainer (not marked) is provided on the inner edge of the hole (416) to receive an insertion piece (417). The hole (411) in size corresponding to that of the projection pattern piece (1B) is provided at the center of the insertion piece (417) and a retaining wall (418) is provided on the inner edge of the hole (411) to secure the lens (2) in position, or alternatively, said lens (2) may be glued or fused, finally, the housing (41B) is locked up to the front end of a barrel (42B) of a flashlight casing (4B) to project the beams emitted from the light source (3) to from an image of a pattern piece selected.

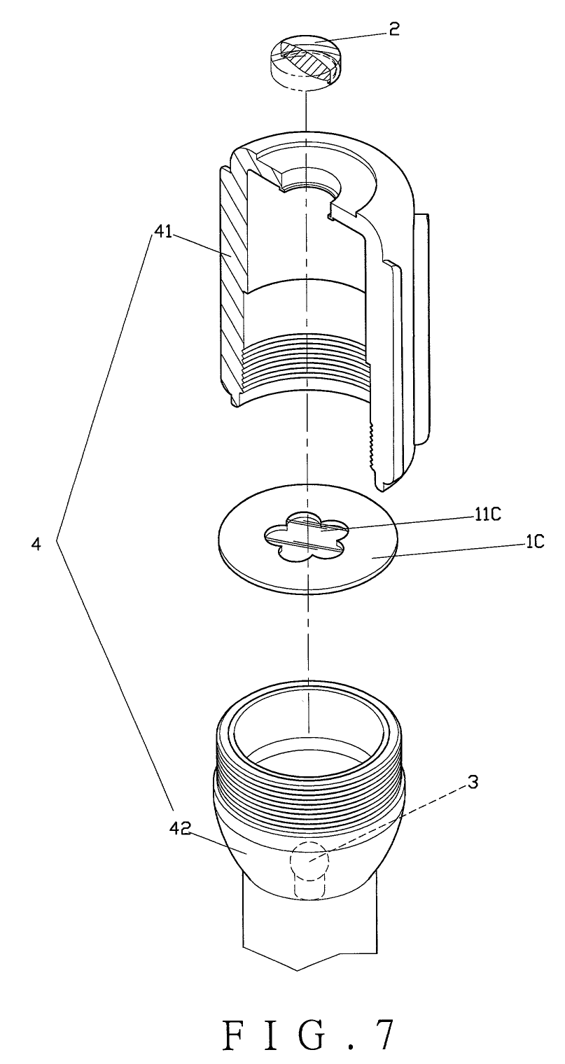

As illustrated in FIG. 7, a fourth preferred embodiment of the present invention. It differs from the first preferred embodiment in a projection pattern piece (1C). The pattern piece (1C) is in the form of a transparency having at its center provided with a transparent area (11C) printed with pattern, instead of a hollowed-out hole.

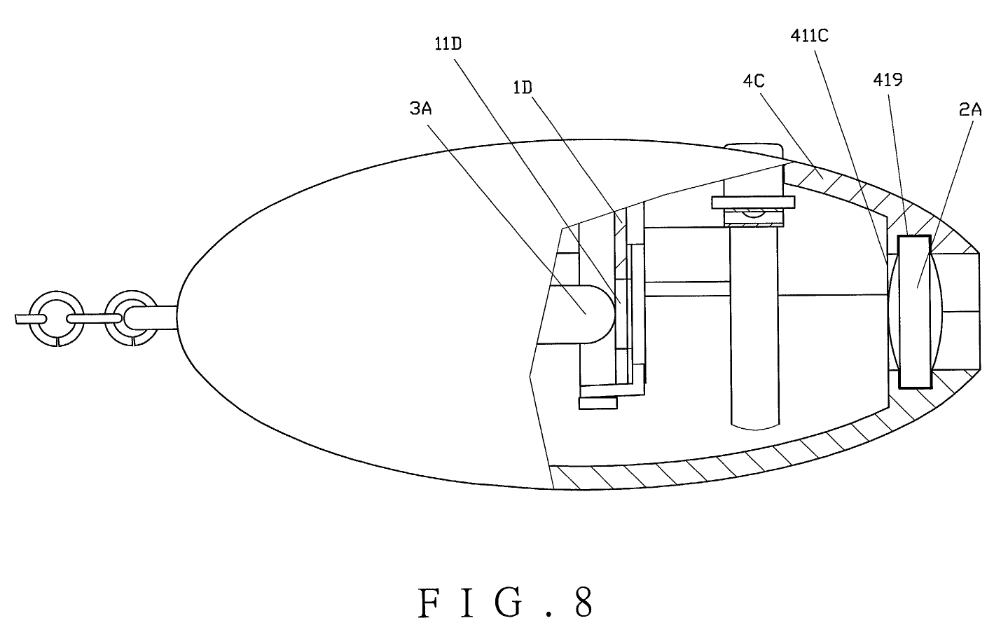

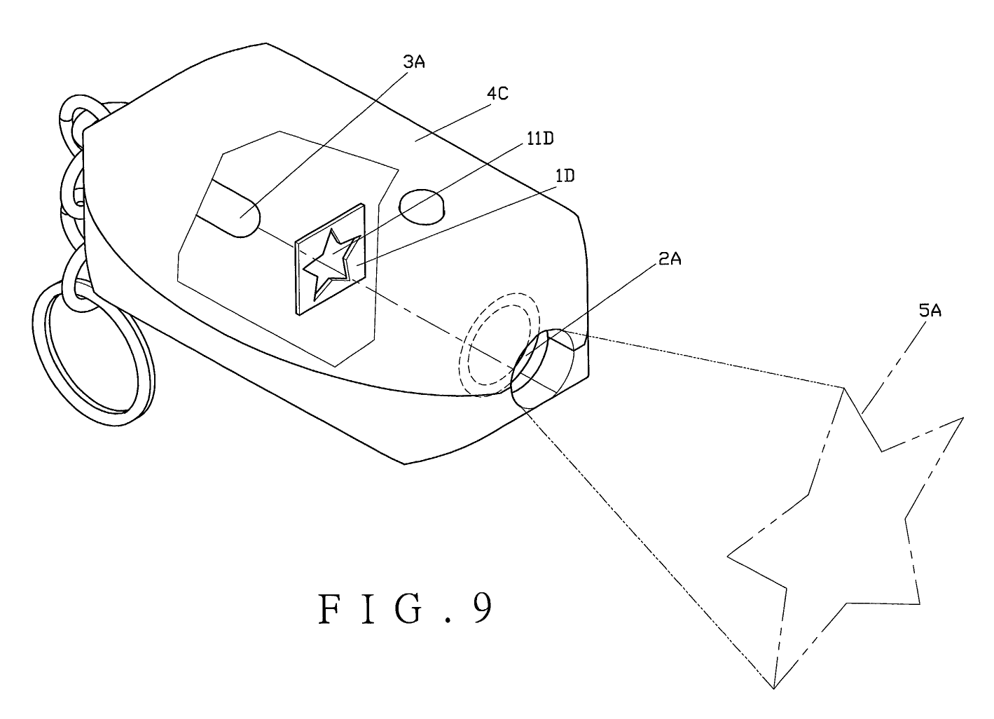

A fifth preferred embodiment of the present invention as illustrated in FIG. 8 is applied in a key-chain light. The light source is disposed in a casing (4C) and a projection pattern piece (1D) is placed in front of a light source (3). A corresponding insertion hole (419) is provided to the casing (4C) in front of the projection pattern piece (1D) to receive a lens (2A) so that a hollowed-out hole (11D) of the projection pattern piece (1D) is aligned at both of the light source (3) and the lens (2A). Accordingly, an enlarged image (5A) is projected when the light source (3) is on as illustrated in FIG. 9.

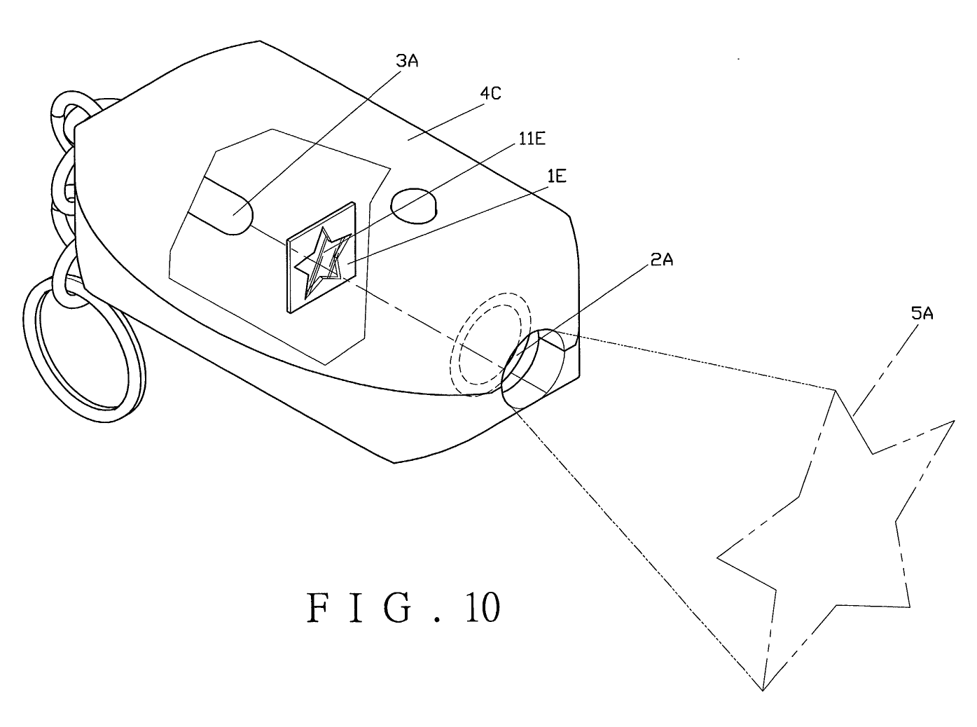

Now referring to FIG. 10, a sixth preferred embodiment of the present invention differs the fifth preferred embodiment in that a projection pattern piece (1E) is in the form of a transparency having at its center provided with a transparent area (11E) with a pattern, instead of a hollowed-out hole. An enlarged image (5A) is projected when the light source (3) is on.

I claim:

1. A lighting fixture with image projection effects comprising a projection pattern piece, a lens, a light source and a casing; wherein, the light source being provided inside the casing; a through hole being provided axially in front of the casing; the lens being inserted into the through hole; the projection pattern piece being placed between the light source and the lens; and the projection pattern piece being hollowed out at its center in a contour of a selected pattern; light beams emitted from the light source being projected through the hollowed-out hole to the lens, then converged and amplified to project the image of the pattern.

2. A lighting fixture with image projection effects as claimed in claim 1, wherein, the lens is a convex lens or a plano-convex lens.

3. A lighting fixture with image projection effects as claimed in claim 1, wherein, the projection pattern piece is a transparency and the hollowed-out hole in the projection pattern piece is replaced with a transparent area.

4. A lighting fixture with image projection effects as claimed in claim 1, wherein, the casing comprises a housing and a barrel with a retaining wall provided on the inner of the housing to hold the projection pattern piece in position.

5. A lighting fixture with image projection effects as claimed in claim 1, wherein, the casing comprises a housing and a barrel with the projection pattern piece being directly formed on the inner of the housing.

6. A lighting fixture with image projection effects as claimed in claim 6, wherein, the casing comprises a housing and a barrel with a slot provided in radius on the housing to exchange the projection pattern piece from the exterior of the housing by insertion.

7. A lighting fixture with image projection effects as claimed in claim 6, two bits opposite to each other are provided on the projection pattern piece.
